(19) United States
(12) Patent Application Publication
(10) Pub. No.: US 2025/0322977 A1
(43) Pub. Date: Oct. 16, 2025

(54) COMPOSITE CABLE

(71) Applicant: Proterial, Ltd., Tokyo (JP)

(72) Inventors: Yoshikazu HAYAKAWA, Ibaraki (JP); Hirotaka ESHIMA, Tokyo (JP); Tomoyuki MURAYAMA, Tokyo (JP); Takahiro FUTATSUMORI, Mito-shi (JP)

(21) Appl. No.: 19/180,602

(22) Filed: Apr. 16, 2025

(30) Foreign Application Priority Data
Apr. 16, 2024 (JP) 2024-066112

(51) Int. Cl. H01B 7/18; H01B 7/00; H01B 9/00

(52) U.S. Cl. CPC H01B 7/18; H01B 9/003; H01B 7/0045

(57) ABSTRACT

A composite cable is provided with a plurality of insulated wires, each including a conductor wire made of a conductive metal covered with an insulator made of a resin, an inner sheath covering some insulated wires of the plurality of insulated wires, and an outer sheath collectively covering the plurality of insulated wires and the inner sheath, wherein a bending rigidity of at least one insulated wire not covered by the inner sheath of the plurality of insulated wires is higher than a bending rigidity of the some insulated wires covered by the inner sheath.

### CROSS-REFERENCE TO RELATED APPLICATIONS

The present patent application claims the priority of Japanese patent application No. 2024-066112 filed on Apr. 16, 2024, and the entire contents thereof are hereby incorporated by reference.

### TECHNICAL FIELD

This invention relates to a composite cable in which a plurality of wires (i.e., electric wires) are collectively covered by an outer sheath.

### BACKGROUND OF THE INVENTION

Conventional composite cables, in which a plurality of wires are collectively covered by an outer sheath, are connected between the unsprung part (i.e., under-spring part) and the sprung part (i.e., over-spring part) of a vehicle (see, for example, Patent Literature 1).

Patent Literature 1 describes a wire harness comprising an ABS cable composed of two insulated wires, each of which comprises a conductor coated by an insulator, being covered by an inner sheath, an ADS cable composed of two insulated wires, each of which comprises a conductor coated by an insulator, being twisted in pairs, an EPB cable composed of two insulated wires, each of which comprises a conductor coated by an insulator, being twisted in pairs, and outer sheath collectively covering the ABS cable, the ADS cable, and the EPB cable. The ABS cable is connected to an ABS sensor that detects the rotation speed of a wheel, the ADS cable is connected to a variable damping force damper whose damping force can be adjusted, and the EPB cable is connected to an electric parking brake device and supplies operating power to the electric parking brake device.

### CITATION LIST

Patent Literature 1: JP2023-139571A

### SUMMARY OF THE INVENTION

As described in Patent Literature 1, cables connected between the unsprung part and the sprung part of a vehicle are repeatedly bent by the vertical movement of the vehicle wheels relative to the vehicle body. Depending on the curvature and frequency of bending, the insulated wire of the ADS cable, which is not coated by the inner sheath and is thinner than the EPB cable, may buckle, and bending stress is likely to be concentrated in the buckled area. This concentration of stress leads to a decrease in bending durability. Here, “buckling” refers to localized bending in a portion of the longitudinal direction. Therefore, the object of the present invention is to provide a composite cable in which buckling of the insulated wire is less likely to occur, thereby improving bending durability.

For solving the above problem, one aspect of the present invention provides a composite cable, comprising:
a plurality of insulated wires, each comprising a conductor wire comprising a conductive metal covered with an insulator comprising a resin;
an inner sheath covering some insulated wires of the plurality of insulated wires; and
an outer sheath collectively covering the plurality of insulated wires and the inner sheath, wherein a bending rigidity of at least one insulated wire not covered by the inner sheath of the plurality of insulated wires is higher than a bending rigidity of the some insulated wires covered by the inner sheath.

### Advantageous Effects of the Invention

According to the present invention, it is possible to provide a composite cable in which buckling of the insulated wire is less likely to occur, thereby improving bending durability.

### BRIEF DESCRIPTION OF DRAWINGS

FIG. 1 is a schematic diagram illustrating a configuration of a composite cable in an embodiment of the present invention and a vehicle wheel-side and a vehicle body-side connected by the composite cable.

FIG. 2 is a cross-sectional view of the composite cable at line A-A in FIG. 1.

FIG. 3 is an explanatory diagram showing ends of first and second insulated wires without an inner sheath of an ABS cable.

FIG. 4 is an explanatory diagram showing an end of an ADS cable.

FIG. 5 is an explanatory diagram showing an end of an EPB cable.

FIG. 6 is a cross-sectional view of a composite cable in modified example 1.

FIGS. 7A and 7B are cross-sectional views of a composite cable in modified example 2.

### DETAILED DESCRIPTION OF THE INVENTION

### Embodiment

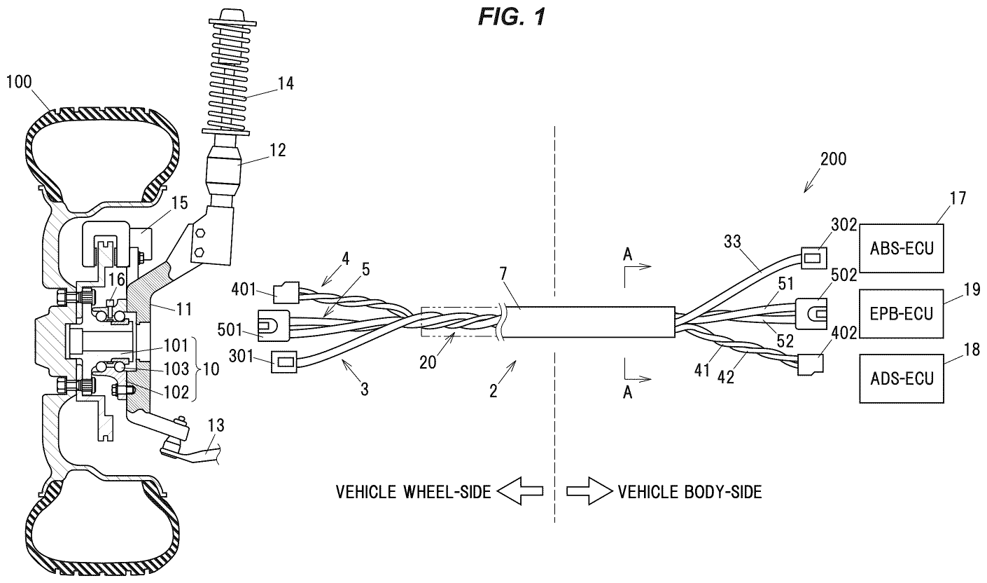

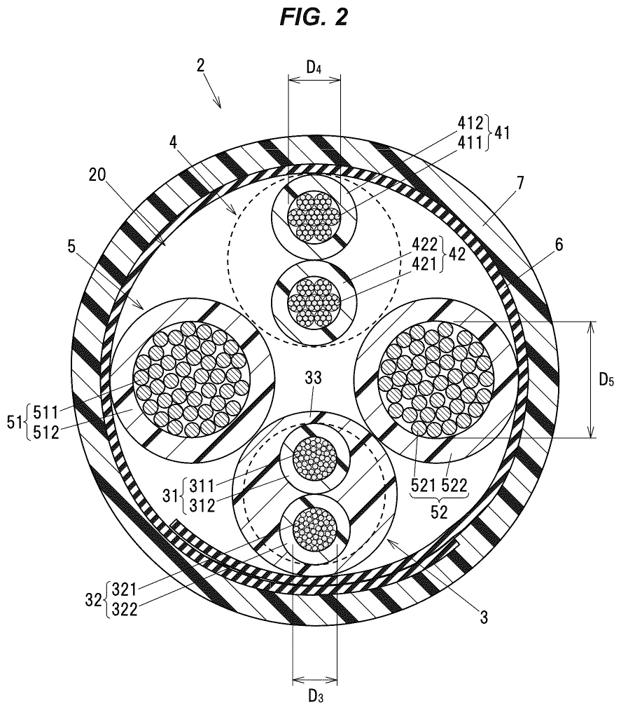

FIG. 1 is a schematic diagram of a configuration of a composite cable 2 in an embodiment of the present invention and a vehicle wheel-side and a vehicle body-side connected by the composite cable 2. FIG. 2 is a cross-sectional view of the composite cable 2 at the A-A line in FIG. 1.

FIG. 1 shows one vehicle wheel 100 of a plurality of vehicle wheels of a vehicle, a hub unit 10 that rotatably supports the vehicle wheel, a knuckle 11 to which the hub unit 10 is attached, a variable damping force damper 12 and a lower arm 13 connected to the knuckle 11, a suspension spring 14 located on an outer circumference of the variable damping force damper 12, an electric parking brake device 15, and a wheel speed sensor 16.

The hub unit 10 has a hub wheel 101 to which the vehicle wheel 100 is fixed, an outer wheel 102 fixed to the knuckle 11, and rolling elements 103 arranged in a double row between the hub wheel 101 and the outer wheel 102. The variable damping force damper 12 is a damper whose damping force can be adjusted electrically according to the electric current supplied. The electric parking brake device 15 is fixed to the knuckle 11 and locks the vehicle wheel 100 so it does not rotate when the vehicle is stopped. The wheel speed sensor 16 detects the rotation speed of the hub wheel 101 relative to the outer wheel 102 as the rotation speed of the vehicle wheel 100.

The composite cable 2 is arranged over the area between the unsprung part, which is the portion that moves up and down with respect to the vehicle body as the suspension springs 14 extend and retract, and the sprung part, which does not move up and down with respect to the vehicle body, and is bent repeatedly as the vehicle wheels 100 move up and down with respect to the vehicle body during vehicle travel. The variable dampers 12, the electric parking brake device 15, and the wheel speed sensor 16 are located under the spring (unsprung).

As shown in FIG. 2, the composite cable 2 has a cable core 20 comprising an ABS (Antilock brake system) cable 3, an ADS (Active damper suspension) cable 4, and an EPB (Electric parking brake) cable 5, being twisted together, a binder tape 6 being spirally wound around an outer circumference of the cable core 20, and an outer sheath 7 being provided around an outer circumference of the binder tape 6. A shield layer may be provided between the binder tape 6 and the outer sheath 7. The ABS cable 3, the ADS cable 4, and the EPB cable 5 are connected to an unsprung part at one end and to a sprung part at the other end, respectively.

FIG. 1 shows the outline of the outer sheath 7 in a portion in a longitudinal direction of the composite cable 2 with a double-dashed line, and shows the binder tape 6 and the cable core 20 inside the outer sheath 7. An ABS-ECU 17, an ADS-ECU 18, and an EPB-ECU 19 shown in FIG. 1 are control units (ECU: Electronic Control Unit) located at the sprung part on the vehicle body-side.

A vehicle wheel-side ABS connector 301 and a vehicle body-side ABS connector 302 are attached to one end and the other end of the ABS cable 3, respectively. The vehicle wheel-side ABS connector 301 is connected to the wheel speed sensor 16, and the vehicle body-side ABS connector 302 is connected to the ABS-ECU 17. The ABS cable 3 transmits detection signals of the wheel speed sensor 16 to the ABS-ECU 17.

The vehicle wheel-side ADS connector 401 and the vehicle body-side ADS connector 402 are attached to one end and the other end of the ADS cable 4, respectively. The vehicle wheel-side ADS connector 401 is connected to the variable damping force damper 12, and the vehicle body-side ADS connector 402 is connected to the ADS-ECU 18. The variable damping force damper 12 dampens the stretching vibration (i.e., expansion and contraction vibration) of the suspension spring 14 with a damping force corresponding to the electric current supplied by the ADS-ECU 18 via the ADS cable 4.

The vehicle wheel-side EPB connector 501 and the vehicle body-side EPB connector 502 are attached to one end and the other end of the EPB cable 5, respectively. The vehicle wheel-side EPB connector 501 is connected to the electric parking brake device 15 and the vehicle body-side EPB connector 502 is connected to the EPB-ECU 19. The EPB cable 5 is a power line that supplies operating power to the electric parking brake device 15.

The composite cable 2, together with the vehicle wheel-side ABS connector 301 and vehicle body-side ABS connector 302, the vehicle wheel-side ADS connector 401 and vehicle body-side ADS connector 402, and the vehicle wheel-side EPB connector 501 and vehicle body-side EPB connector 502, constitute a wiring harness 200. The lengths of the ABS cable 3, ADS cable 4, and EPB cable 5 in exposed portions from the outer sheath 7 vary depending on the location of the respective connection targets. The ABS cable 3, ADS cable 4, and EPB cable 5 may be connected to the ABS-ECU 17, ADS-ECU 18, and EPB-ECU 19, respectively via relay cables.

The ABS cable 3 has first and second insulated wires 31, 32, and an inner sheath 33 covering the first and second insulated wires 31, 32. The ADS cable 4 has third and fourth insulated wires 41, 42. The EPB cable 5 has fifth and sixth insulated wires 51, 52. In other words, the composite cable 2 has the first to sixth insulated wires 31, 32, 41, 42, 51, 52, the inner sheath 33 covering the first and second insulated wires 31, 32, which are part of the first to sixth insulated wires 31, 32, 41, 42, 51, 52, the binder tape 6, and the outer sheath 7.

The first and second insulated wires 31, 32 of the ABS cable 3, the third and fourth insulated wires 41, 42 of the ADS cable 4, and the fifth and sixth insulated wires 51, 52 of the EPB cable 5 are twisted together. The binder tape 6 is composed of a non-woven fabric made of, e.g., polyester, polypropylene, aramid fiber, nylon, acrylic fiber, or glass fiber. The inner sheath 33 and outer sheath 7 are made of, e.g., a flexible and durable thermoplastic urethane.

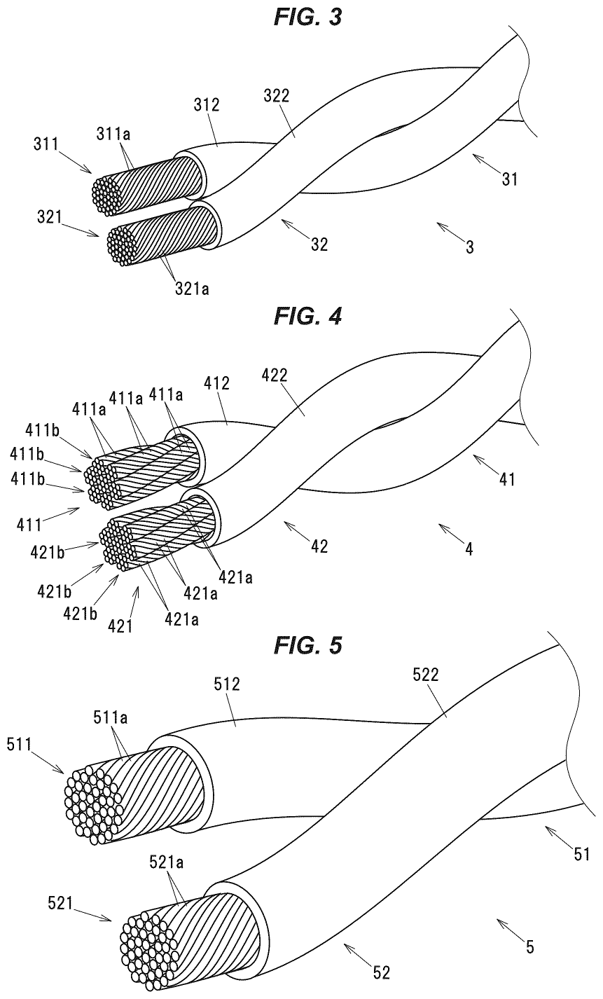

FIG. 3 is an explanatory diagram showing the ends of the first and second insulated wires 31, 32 without the inner sheath 33 of the ABS cable 3. The first and second insulated wires 31, 32 have conductor wires 311, 321 made of conductive metal and insulators 312, 322 made of insulating resin covering the conductor wires 311, 321, respectively, and are twisted together in a spiral shape inside the inner sheath 33. The conductor wires 311, 321 are collective stranded wires, respectively, comprising a plurality of metal strands 311a, 321a bundled and twisted together in the same direction. The first and second insulated wires 31, 32 correspond to “some insulated wires covered by an inner sheath” in the present invention.

FIG. 4 is an explanatory diagram showing the end of the ADS cable 4. The third and fourth insulated wires 41, 42 have conductor wires 411, 421 made of conductive metal and insulators 412, 422 made of insulating resin covering the conductor wires 411, 421, respectively. The conductor wires 411, 421 are composite stranded wires, each of which comprises a plurality of child stranded wires 411b, 421b twisted together, each comprising a plurality of metal strands 411a, 421a twisted together. In the example shown in FIG. 4, seven child stranded wires 411b, 421b are parent twisted to form the conductor wires 411, 421, but there is no restriction on the number of child stranded wires 411b, 421b to be parent twisted. The third and fourth insulated wires 41, 42 correspond to “at least one insulated wire not covered by an inner sheath” in the present invention.

FIG. 5 is an explanatory diagram showing the end of the EPB cable 5. The fifth and sixth insulated wires 51, 52 have conductor wires 511, 521 made of conductive metal and insulators 512, 522 made of insulating resin covering the conductor wires 511, 521, respectively. The conductor wires 511, 521 are collective stranded wires comprising a plurality of metal strands 511a, 521a bundled and twisted together in the same direction.

In FIG. 2, the conductor wire diameters of the first and second insulated wires 31, 32 of the ABS cable 3, the third and fourth insulated wires 41, 42 of the ADS cable 4, and the fifth and sixth insulated wires 51, 52 of the EPB cable 5 are indicated by D₃, D₄, and D₅, respectively. Each conductor wire diameter D₃, D₄, and D₅ has the relationship D₃<D₄<D₅, and D₅ is equal to or more than twice D₃.

When the composite cable 2 constructed as described above is bent during vehicle travel, buckling is more likely to occur in the third and fourth insulated wires 41, 42 of the ADS cable 4, which are not covered by the inner sheath 33 and have smaller conductor wire diameters than the fifth and sixth insulated wires 51, 52 of the EPB cable 5, than the first and second insulated wires 31, 32 of the ABS cable 3 and the fifth and sixth insulated wires 51, 52 of the EPB cable 5.

Therefore, in the present embodiment, buckling of the third and fourth insulated wires 41, 42 is suppressed by making the bending rigidity of the third and fourth insulated wires 41, 42 higher than that of the first and second insulated wires 31, 32. Specifically, the buckling of the third and fourth insulated wires 41, 42 is suppressed by the first to fourth means described below. However, if the buckling of the third and fourth insulated wires 41, 42 can be suppressed by any of the first to fourth means, other means may not be used.

The first means is to use as the metal material for the conductor wires 411, 421 of the third and fourth insulated wires 41, 42 a metal material with higher bending rigidity and harder than the metal material of the conductor wires 311, 321 of the first and second insulated wires 31, 32. For example, by varying the ratio of an additive element (e.g., tin) to copper, which is the main component, in the metal material of the conductor wires 411, 421 of the third and fourth insulated wires 41, 42 and the metal material of the conductor wires 311, 321 of the first and second insulated wires 31, 32. The rigidity of the conductor wires 411, 421 of the third and fourth insulated wires 41, 42 can be made higher than that of the conductor wires 311, 321 of the first and second insulated wires 31, 32. It is also possible to use wires made of soft copper as the metal strands 311a, 321a of the first and second insulated wires 31, 32, and wires made of hard copper as the metal strands 411a, 421a of the third and fourth insulated wires 41, 42.

The second means is to use as the resin for the insulators 412, 422 of the third and fourth insulated wires 41, 42 a resin material with higher bending rigidity and harder than the resin of the insulators 312, 322 of the first and second insulated wires 31, 32. For example, by using low-density polyethylene as the resin material of the insulators 312, 322 of the first and second insulated wires 31, 32, and using high-density polyethylene as the resin material of the insulators 412, 422 of the third and fourth insulated wires 41, 42, the rigidity of the third and fourth insulated wires 41, 42 is increased from the first and insulated wires 31, 32 can be higher than the rigidity of the first and second insulated wires 31, 32. Polybutylene terephthalate (PBT) or ethylene tetrafluoroethylene (ETFE), a copolymer of tetrafluoroethylene and ethylene, may also be used as the resin material for the insulators 412, 422 of the third and fourth insulated wires 41, 42. The third and fourth insulators may also be used. Furthermore, by making the thickness of the insulators 412, 422 of the third and fourth insulated wires 41, 42 thicker than the insulators 312, 322 of the first and second insulated wires 31, 32, the bending rigidity of the third and fourth insulated wires 41, 42 can also be increased over the first and second insulated wires 31, 32.

The third means is to make the conductor wire diameter D₄ of the conductor wires 411, 421 of the third and fourth insulated wires 41, 42 larger than the conductor wire diameter D₃ of the conductor wires 311, 321 of the first and second insulated wires 31, 32. The conductor wire diameters D₄ of the conductor wires 411, 421 of the third and fourth insulated wires 41, 42 are, e.g., 1.2 to 2.0 times (i.e., 1.2 times or more and 2.0 times or less) larger than the conductor wire diameters D₃ of the conductor wires 311, 321 of the first and second insulated wires 31, 32.

The fourth means is to make the conductor wires 311, 321 of the first and second insulated wires 31, 32 as collective stranded wires and the conductor wires 411, 421 of the third and fourth insulated wires 41, 42 as composite stranded wires. By making the conductor wires 411, 421 of the third and fourth insulated wires 41, 42 composite stranded wires, the conductor wires 411, 421 are less likely to collapse in the bending direction even when the third and fourth insulated wires 41, 42 are bent, and the bending rigidity of the third and fourth insulated wires 41, 42 is higher than that of the first and second insulated wires 31, 32. The bending rigidity of the third and fourth insulated wires 41, 42 can be increased.

The materials of conductor wires 511, 521 and insulators 512, 522 of the fifth and sixth insulated wires 51, 52 can be the same as those of conductor wires 311, 321 and insulators 312, 322 of the first and second insulated wires 31, 32, for example.

### (Effects of the Embodiment)

According to the above-described embodiment, the occurrence of buckling in the third and fourth insulated wires 41 and 42, which are relatively prone to buckling among the first to sixth insulated wires 31, 32, 41, 42, 51, 52, can be suppressed, and the bending durability of the composite cable 2 can be improved.

### Modified Example 1

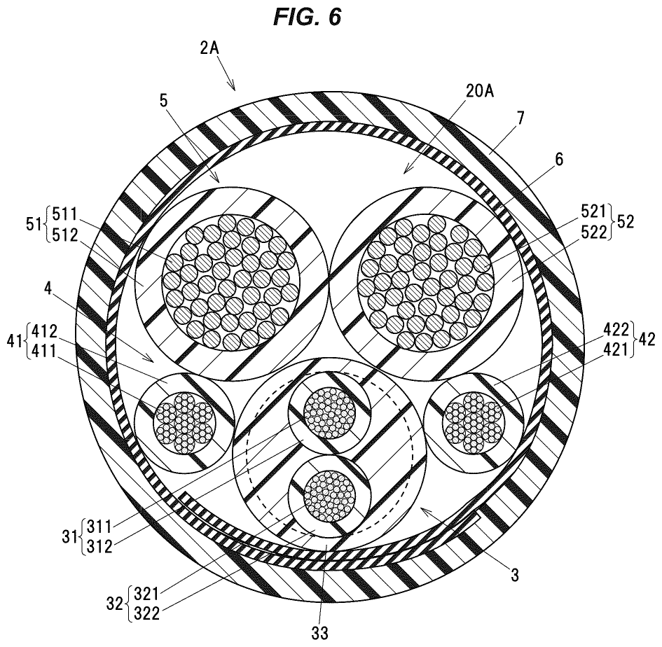

FIG. 6 is a cross-sectional view of the composite cable 2A in modified example 1. In the above embodiment, the case in which the third and fourth insulated wires 41, 42 of the ADS cable 4 are twisted together with each other is described, but in modified example 1 shown in FIG. 6, the ABS cable 3 is placed between the third insulated wire 41 and the fourth insulated wire 42 of the ADS cable 4, and the third insulated wire 41 and the fourth insulated wire 42 are twisted together with the ABS cable 3 and the EPB cable 5 in a spiral shape to form the cable core 20A. Other configurations and materials of each part are the same as in the above embodiment. With this modified example 1, as in the above embodiment, the occurrence of buckling in the third insulated wire 41 and the fourth insulated wire 42 can be suppressed, and the bending durability of the composite cable 2A can be improved. According to modified example 1, the cable core 20A can be made thinner than in the above embodiment, thereby making it possible to reduce the diameter of the composite cable 2A.

### Modified Example 2

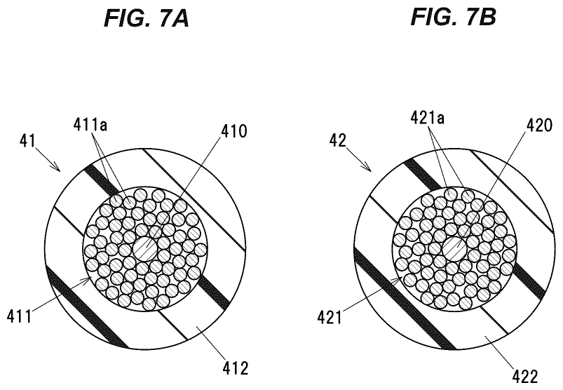

FIGS. 7A and 7B are cross-sectional views of the third and fourth insulated wires 41, 42 in modified example 2. In the above embodiment, the case in which the third and fourth insulated wires 41, 42 of the ADS cable 4 are composite stranded wires was described, but in modified example 2 shown in FIG. 7, highly rigid wires 410, 420 with high bending rigidity are arranged in the center of each of the conductor wires 411, 421 of the third and fourth insulated wires 41, 42, and a plurality of metal strands 411a, 421a are arranged in a spiral shape around the highly rigid wires 410, 420, so that the bending rigidity of the third and fourth insulated wires 41, 42 is increased. The highly rigid wires 410, 420 can be made of a metal wire that is thicker than the metal strands 411a, 421a and harder than the metal strands 411a, 421a, for example. The material of the metal strands 411a, 421a and insulators 412, 422 may be the same as the metal strands 311a, 321a and insulators 312, 322 of the conductor wires 311, 321 of the first and second insulated wires 31, 32. This modified example 2 can also suppress the occurrence of buckling in the third and fourth insulated wires 41, 42, as in the above embodiment.

### (Summary of the Embodiment and Modified Examples)

Next, the technical concepts that can be grasped from the above embodiment and modified examples will be described with the help of the codes in the embodiment and modified examples. However, each code in the following description does not limit the components in the claims to the parts, etc. specifically shown in the embodiment and modified examples.

According to the first feature, a composite cable 2, 2A includes a plurality of insulated wires 31, 32, 41, 42, 51, 52, each comprising a conductor wire 311, 321, 411, 421, 511, 521 made of conductive metal covered with an insulator 312, 322, 412, 422, 512, 522 made of resin, and an inner sheath 33 covering some insulated wires 31, 32 of the plurality of insulated wires 31, 32, 41, 42, 51, 52, and an outer sheath 7 collectively covering the plurality of insulated wires 31, 32, 41, 42, 51, 52 and the inner sheath 33, wherein bending rigidity of at least one insulated wire 41, 42 not covered by the inner sheath 33 of the plurality of insulated wires 31, 32, 41, 42, 51, 52 is higher than bending rigidity of the some insulated wires 31, 32 covered by the inner sheath 33.

According to the second feature, in the composite cable 2, 2A as described in the first feature, the conductor wire 411, 421 of the at least one insulated wire 41, 42 not covered by the inner sheath 33 comprises a harder metal with higher bending rigidity than a metal of the conductor wire 311, 321 of the some insulated wires 31, 32 covered by the inner sheath 33.

According to the third feature, in the composite cable 2, 2A as described in the first feature, the insulator 412, 422 of the at least one insulated wire 41, 42 not covered by the inner sheath 33 comprises a resin having higher bending rigidity than a resin of the insulator 312, 322 of the some insulated wires 31, 32 covered by the inner sheath 33.

According to the fourth feature, in the composite cable 2, 2A as described in the first feature, the conductor wire 311, 321 of the some insulated wires 31, 32 covered by the inner sheath 33 is a collective twisted wire comprising a plurality of metal strands 311a, 321a twisted together in the same direction, and the conductor wire 411, 421 of the at least one insulated wire 41, 42 is a composite stranded wire comprising child stranded wires 411b, 421b twisted together, each comprising a plurality of metal strands 411a, 421a twisted together.

According to the fifth feature, in the composite cable 2, 2A as described in the first feature, a conductor wire diameter D₄ of the at least one insulated wire 41, 42 not covered by the inner sheath 33 is larger than a conductor wire diameter D₃ of the some insulated wires 31, 32 covered by the inner sheath 33.

According to the sixth feature, in the composite cable 2, 2A of any of the first to fifth features, the plurality of insulated wires 31, 32, 41, 42, 51, 52 are each connected at one end to an unsprung part of a vehicle and at the other end to a sprung part of the vehicle.

According to the seventh feature, in the composite cable 2, 2A as described in the sixth feature, the some insulated wires 31, 32 covered by the inner sheath 33 are connected at the one end to a wheel speed sensor 16 that detects the rotation speed of a vehicle wheel 100.

According to the eighth feature, in the composite cable 2, 2A as described in the sixth feature, the at least one insulated wire 41, 42 not covered by the inner sheath 33 is connected at the one end to a variable damping force damper 12 with adjustable damping force.

According to the ninth feature, in the composite cable 2, 2A as described in the sixth feature, the plurality of insulated wires 31, 32, 41, 42, 51, 52 includes a power line 51, 52 that supplies an operating power supply to an electric parking brake device 15 located under a spring of the vehicle.

The above description of the embodiment of the invention does not limit the invention to the scope of the claims. It should also be noted that not all of the combinations of features described in the embodiment are essential to the invention. In the above embodiment, the case in which the composite cable 2 is arranged over the unsprung part and the sprung part of a vehicle is described, but the application of the composite cable of the invention is not limited to this, and it is also possible to use it for industrial machinery, for example, other than for vehicles.

In the above embodiment, the detection signal of the wheel speed sensor 16 is transmitted by the first and second insulated wires 31, 32, and the current is supplied to the variable damping force damper 12 by the third and fourth insulated wires 41, 42. For example, the third and fourth insulated wires 41, 42 may be used to transmit signals related to the control of the electric parking brake device 15 or an electric brake device that brakes the vehicle wheel 100 while the vehicle is in motion.

In the above embodiment, the case in which the rigidity of the two insulated wires 41, 42 not covered by an inner sheath 33 of the ADS cable 4 is higher than that of the two insulated wires 31, 32 covered by the inner sheath 33 of the ABS cable 3 is described. At least one insulated wire, to which the above first to fourth means of suppressing buckling by increasing the rigidity is applicable, is sufficient.

1. A composite cable, comprising:
a plurality of insulated wires, each comprising a conductor wire comprising a conductive metal covered with an insulator comprising a resin;
an inner sheath covering some insulated wires of the plurality of insulated wires; and
an outer sheath collectively covering the plurality of insulated wires and the inner sheath,
wherein a bending rigidity of at least one insulated wire not covered by the inner sheath of the plurality of insulated wires is higher than a bending rigidity of the some insulated wires covered by the inner sheath.

2. The composite cable, according to claim 1, wherein the conductor wire of the at least one insulated wire not covered by the inner sheath comprises a harder metal with higher bending rigidity than a metal of the conductor wire of the some insulated wires covered by the inner sheath.

3. The composite cable, according to claim 1, wherein the insulator of the at least one insulated wire not covered by the inner sheath comprises a resin having higher bending rigidity than a resin of the insulator of the some insulated wires covered by the inner sheath.

4. The composite cable, according to claim 1, wherein the conductor wire of the some insulated wires covered by the inner sheath is a collective twisted wire comprising a plurality of metal strands twisted together in a same direction, and the conductor wire of the at least one insulated wire is a composite stranded wire comprising child stranded wires twisted together, each comprising a plurality of metal strands twisted together.

5. The composite cable, according to claim 1, wherein a conductor wire diameter of the at least one insulated wire not covered by the inner sheath is larger than a conductor wire diameter of the some insulated wires covered by the inner sheath.

6. The composite cable, according to claim 1, wherein the plurality of insulated wires are each connected at one end to an unsprung part of a vehicle and at an other end to a sprung part of the vehicle.

7. The composite cable, according to claim 6, wherein the some insulated wires covered by the inner sheath are connected at the one end to a wheel speed sensor that detects a rotation speed of a vehicle wheel.

8. The composite cable, according to claim 6, wherein the at least one insulated wire not covered by the inner sheath is connected at the one end to a variable damping force damper with adjustable damping force.

9. The composite cable, according to claim 6, wherein the plurality of insulated wires includes a power line that supplies an operating power supply to an electric parking brake device located under a spring of the vehicle.
